(19) United States
(12) Patent Application Publication
(10) Pub. No.: US 2008/0261664 A1
(43) Pub. Date: Oct. 23, 2008

(54) COVER FOR ELECTRONIC DEVICE

(75) Inventor: Julian Parry, Sarasota, FL (US)

Correspondence Address: GIFFORD, KRASS, SPRINKLE,ANDERSON & CITKOWSKI, P.C, PO BOX 7021, TROY, MI, 48007-7021, US

(73) Assignee: Fun Friends, Inc., Sarasota, FL (US)

(21) Appl. No.: 12/106,366

(22) Filed: Apr. 21, 2008

Related U.S. Application Data
(60) Provisional application No. 60/925,598, filed on Apr. 20, 2007.

(51) Int. Cl. H04M 1/00

(52) U.S. Cl. 455/575.3

(57) ABSTRACT

A plush cover for a flip style cell phone is provided. The cover can include a top half having a first pocket, the first pocket being dimensioned to accept a top portion of a flip style cell phone, and a second half having a second pocket. The second pocket is dimensioned to accept a bottom portion of a flip style cell phone. The cover also has a front surface that extends across the top half and the second half, with at least part of the front surface being in the shape of a figurine. The top half can include an aperture that is dimensioned and located such that a user can view a backside display of a flip style cell phone placed within the cover. In addition, an elastic piece having a first end and a second end can be included, with the first end attached to a lower region of the top half and the second end attached to a bottom region of the aperture. The elastic piece affords for the cell phone cover to fit cell phones of different sizes.

### CROSS-REFERENCE TO RELATED APPLICATIONS

This application claims priority of U.S. Provisional Patent Application Ser. No. 60/925,598 filed Apr. 20, 2007, which is incorporated herein by reference.

### FIELD OF THE INVENTION

The present invention is related to a cover for an electronic device, and more particularly, related to a cover for a flip style cell phone.

### BACKGROUND OF THE INVENTION

The use of cell phones, portable media players and remote control devices is common. Each device is conveniently applicable to be picked up and carried by a user. However, methods to protect such a device have been limited to leather and plastic pouches, and the like. In addition such devices can be easily misplaced and thereby difficult to find. Therefore, there is a need for a cover which provides protection to an electronic device held therein. In addition, there is a need for a cover that can increase a user's ability to locate an electronic device when misplaced.

### SUMMARY OF THE INVENTION

A cover for a flip style cell phone is provided. The cover can include a top half having a first pocket, the first pocket being dimensioned to accept a top portion of a flip style cell phone, and a second half having a second pocket. The second pocket is dimensioned to accept a bottom portion of a flip style cell phone. The cover also has a front surface that extends across the top half and the second half, with at least part of the front surface being in the shape of a figurine. The top half can include an aperture that is dimensioned and located such that a user can view a backside display of a flip style cell phone placed within the cover. In addition, an elastic piece having a first end and a second end can be included, with the first end attached to a lower region of the top half and the second end attached to a bottom region of the aperture. The elastic piece affords for the cell phone cover to fit cell phones of different sizes.

### BRIEF DESCRIPTION OF THE DRAWINGS

FIG. 1 is a perspective view of an embodiment of the present invention;

FIG. 2 is a perspective view of the embodiment shown in FIG. 1 illustrating an aperture that allows for viewing of a backside display of a cell phone; and

FIG. 3 is a perspective view of the embodiment shown in FIG. 1 without the presence of a cell phone.

### DETAILED DESCRIPTION OF THE INVENTION

A plush cover for a flip style cell phone is provided wherein a front surface includes a figurine, and between a back surface and a pocket sheet is afforded at least one pocket wherein the cell phone can be securely placed. As such, the article of the present invention has utility as a protective cover for the cell phone. In addition, the cover of the present invention has utility in increasing the ability of a user to locate the cell phone when misplaced.

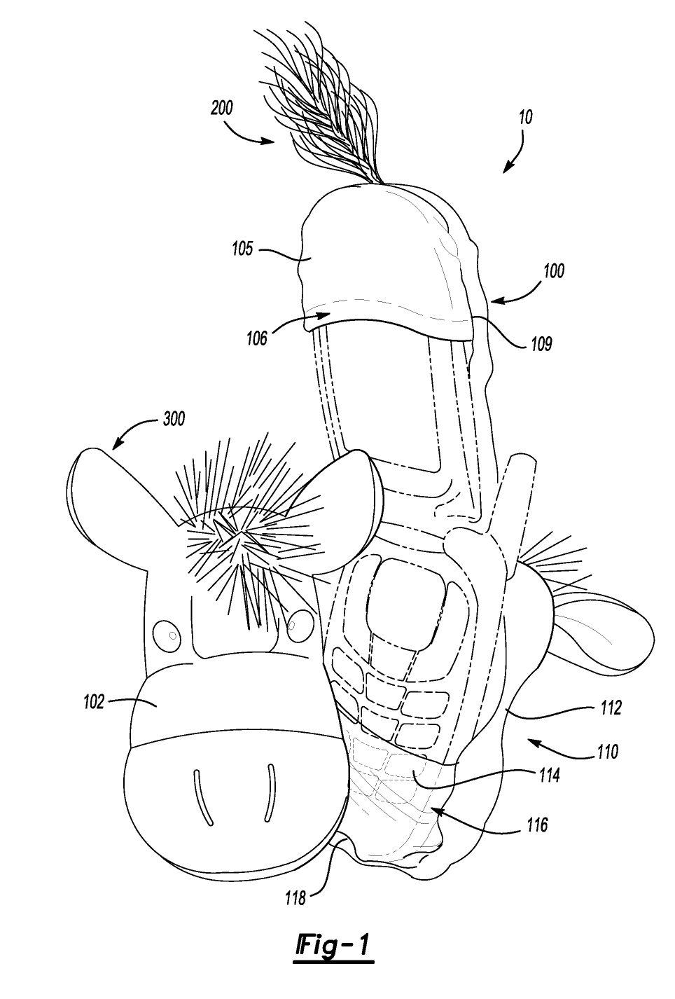

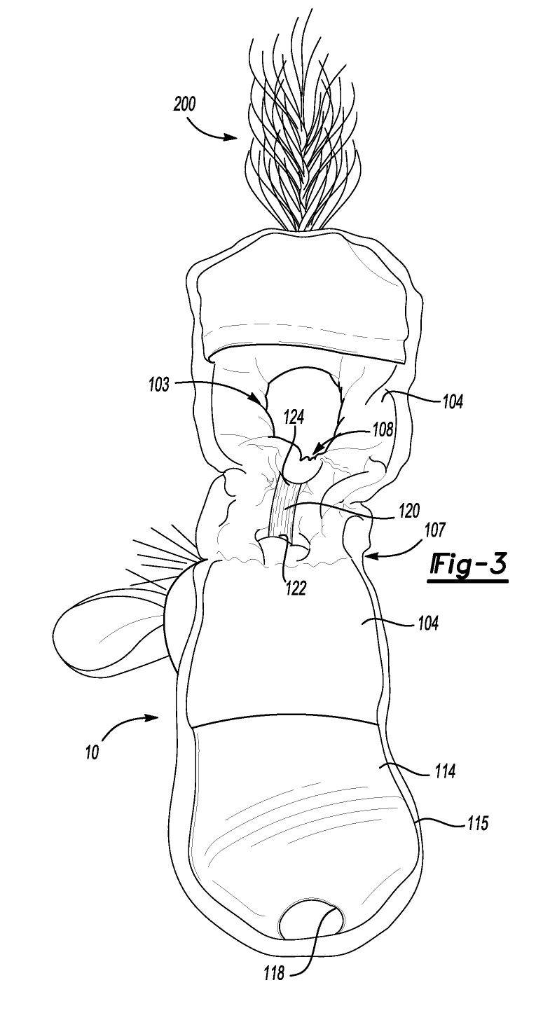

An embodiment of the present invention is shown in FIGS. 1-3. A flip style cell phone cover 10 is shown to include a top half 100 and a bottom half 110. The top half 100 and the bottom half 110 have a front surface 102 and a back surface 104. Between the back surface 104 and a first pocket sheet 105 is a first pocket 106. The first pocket 106 affords for the placement of a top portion of a flip style cell phone. The first pocket sheet 105 has a perimeter edge 109, the perimeter edge 109 being at least partially attached to the back surface 104 of the top half 100 in order to form the first pocket 106. The perimeter edge 109 can be attached to the back surface 104 of the top half 100 using any method known to those skilled in the art, illustratively including sewing, adhesives and the like. In addition, the first pocket sheet 105 can be made from a variety of materials, illustratively including cloth, spandex, leather, plastic and the like.

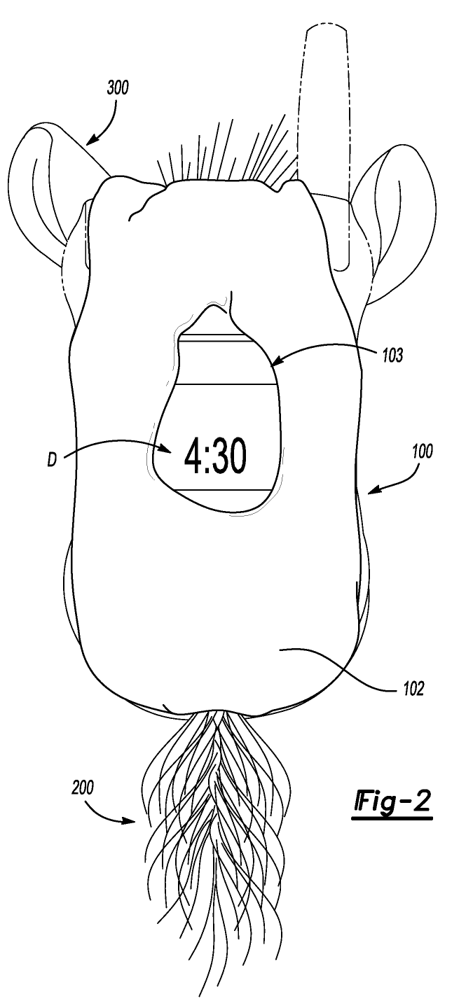

The top half 100 can include an aperture 103 that affords a user to view a backside display D on a cell phone through said cover 10 as shown in FIG. 2. An elastic piece 120 with a first end 122 and a second end 124 can also be included. The first end 122 can be attached to a lower region of the top half 100, for example proximate to a midsection region 107 of the cover 10, and the second end 124 can be attached to a bottom region 108 of the aperture 103. In some instances, the elastic piece 120 is attached to the back surface 104, or in the alternative, the elastic piece 120 can be attached to the front surface 102. It is appreciated that the elastic piece 120 allows for the top half 100 and the cover 10 to fit “snug” onto flip style cell phones of different sizes.

Between the back surface 104 of the bottom half 110 and a second pocket sheet 114 a second pocket 116 can be present. The second pocket 116 affords for the placement of a bottom half of a flip style cell phone. The second pocket sheet 114 has a perimeter edge 115, the perimeter edge 115 being at least partially attached to the back surface 104 of the bottom half 100 in order to form the second pocket 116. The perimeter edge 115 can be attached to the back surface 104 of the bottom half 110 using any method known to those skilled in the art, illustratively including sewing, adhesives and the like. In some instances the second pocket sheet is transparent and affords for a user to view and press keys on a cell phone placed within the cover 10.

The second pocket 116 can include an aperture 118 which allows for electrical communication with the flip style cell phone placed within the cover 10. In some instances the aperture 118 is proximate to a battery recharging receptacle of the cell phone placed within the cover 10 and is dimensioned to allow a cell phone recharging device to fit at least partially therethrough.

The front surface 102 can have the shape of an animal figurine, or in the alternative the shape of a figurine that is not an animal. Although a horse or donkey figurine is shown in the figures, any animal figurine or a figurine of any shape, illustratively including the shape of a cartoon character, superhero character, famous personality, mascot, motor vehicle, company logo, trademark, aircraft, spacecraft, candy wrapper, game piece and the like can be present on the front surface 102. In this manner, a decorative cell phone cover for a flip style cell phone is provided. It is appreciated that such a cover can have an amusing, funny, sad, and the like appearance and thereby provide an image to a user that will aid in locating the cell phone within the cover 10. The cell phone cover 10 can include padding located between the front surface 102 and the back surface 104. The padding can be in the form of foam, cloth and other shock absorbing materials and thereby provides for a protective cover for the cell phone placed therein.

Although not shown in the figures, a ring and/or hook can be included with the cover 10 in order to provide a latch type mechanism for the cover 10. In this manner, the cell phone in the cover 10 can be carried by a user on objects such as backpacks, briefcases, belt loops, and the like. For example and for illustrative purposes only, a ring and/or hook can be attached to the tail 200 and/or the ear 300 of the cover 10 shown in the figures. In this manner, the cover 10 with or without a flip style cell phone therein can be attached to an object and serve as a source of conversation, amusement and the like and/or aid in a user not losing the cover 10 and optionally the cell phone located therein.

In this manner, a plush cover for a flip style cell phone is disclosed wherein said cover provides protection to the cell phone from physical impact and provides entertainment to a user. In addition, the figurine shape that is present on the front surface of the cover can aid a user in remembering and/or visually noticing the location of a misplaced cell phone device held within the cover.

The invention is not restricted to the illustrated examples described above. The examples are not intended as limitations on the scope of the invention. Methods, apparatus, and the like described herein are exemplary and not intended as limitations on the scope of the invention. Changes therein and other uses will occur to those skilled in the art. The scope of the invention is defined by the scope of the claims.

I claim:

1. A plush cover for a flip style cell phone, said cover comprising:
a top half having a first pocket, said first pocket dimensioned to accept a top portion of a flip style cell phone; and
a bottom half having a second pocket, said second pocket dimensioned to accept a bottom portion of the flip style cell phone; and
a front surface extending across said top half and said bottom half, said front surface having at least a portion in the shape of a figurine.

2. The cover of claim 1, wherein said front surface extending across said top half has an aperture, said aperture dimensioned and located to allow a backside display of the flip style cell phone to be viewed therethrough when the flip style cell phone is placed in the cover.

3. The cover of claim 2, further comprising an elastic piece having a first end and a second end, said first end attached to a lower region of said top half and said second end attached to a bottom region of said aperture.

4. The cover of claim 1, wherein said second pocket has an aperture, said aperture dimensioned for a battery recharging device to pass at least partially therethrough.

5. The cover of claim 1, wherein said figurine is an animal figurine.

6. A plush cover for a flip style cell phone, said cover comprising:
a top half having a first pocket, said first pocket dimensioned to accept a top portion of a flip style cell phone; and
a bottom half having a second pocket, said second pocket dimensioned to accept a bottom portion of the flip style cell phone;
a front surface extending across said top half and said bottom half, said front surface having at least a portion in the shape of a figurine;
a back surface oppositely disposed from said front surface, said back surface extending across said top half and said bottom half; and
padding located between said front surface and said back surface.

7. The cover of claim 6, wherein said front surface extending across said top half has an aperture, said aperture dimensioned and located to allow a backside display of a flip style cell phone to be viewed therethrough.

8. The cover of claim 7, further comprising an elastic piece having a first end and a second end, said first end attached to a lower region of said top half back surface and said second end attached to a bottom region of said aperture.

9. The cover of claim 6, wherein said first pocket is located between a first pocket sheet and said top half back surface, said first pocket sheet extending across part of said top half.

10. The cover of claim 9, wherein said first pocket sheet has an outer edge with a perimeter that is at least partially attached to said top half back surface.

11. The cover of claim 10, wherein said outer edge perimeter of said first pocket sheet is at least partially attached to said top half back surface by sewing.

12. The cover of claim 9, wherein said first pocket sheet is made from a stretchable material.

13. The cover of claim 6, wherein said second pocket is located between a second pocket sheet and said bottom half back surface, said second pocket sheet extending across part of said bottom half.

14. The cover of claim 13, wherein said second pocket sheet has an outer edge with a perimeter that is at least partially attached to said bottom half back surface.

15. The cover of claim 14, wherein said outer edge perimeter of said second pocket sheet is at least partially attached to said bottom half back surface by sewing.

16. The cover of claim 13, wherein said second pocket sheet is made from a transparent material.

17. The cover of claim 13, wherein said second pocket has an aperture proximate a flip style cell phone battery recharging receptacle, said aperture dimensioned for a cell phone battery recharging device to pass at least partially therethrough.
